(19) United States
(12) Patent Application Publication
(10) Pub. No.: US 2004/0212175 A1
(43) Pub. Date: Oct. 28, 2004

(54) APPARATUS FOR CONNECTING AND DISCONNECTING A TOWING VEHICLE AND A TOWED VEHICLE

(76) Inventor: Joe M. Jarosek, Temple, TX (US)

Correspondence Address: DAVID G. HENRY, 900 Washington Avenue, 7th Floor, P.O. Box 1470, Waco, TX, 77603-1470, US

(21) Appl. No.: 10/421,362

(22) Filed: Apr. 23, 2003

(51) Int. Cl. B60D 1/00

(52) U.S. Cl. 280/477

(57) ABSTRACT

A device used to actuate hitch assemblies involved in connecting and disconnecting towing and towed vehicles. Embodiments include a rod having a distal, medial, and proximate segment as well as an extension rod having a distal, medial, and proximate segment. The rod and the extension rod may be joined in order to provide greater range for effective use of the device. The rod may be used either to push up or lift on a spring-loaded trailer hitch in order to connect or disconnect the vehicles.

### BACKGROUND OF THE INVENTION

1. Field of the Invention

The present invention is directed toward an apparatus for easing the connecting and disconnecting procedures of a towing vehicle and a towed vehicle, principally a truck or similar vehicle and a trailer containing a spring-loaded hitch, in which the driver does not have to climb into the bed of the towing vehicle to connect or disconnect the vehicles.

2. Background Information

Properly connecting and disconnecting a towing vehicle to a towed vehicle is often a difficult and tedious task. One of the most difficult requirements of the process is the necessity of climbing into the bed of a pickup truck or towing vehicle in order to secure the connection between the vehicles. Such difficulty is exaggerated in the common case of a large pickup truck or towing vehicle. Normally, the connection point is not accessible from a position that would allow a person to make the connection without first climbing into the bed of the pickup truck. Therefore, the driver is forced through the difficult process of climbing into the bed of the pickup truck all the while avoiding the large and awkward surface of the towed vehicle. This difficulty is compounded in the case of a towing vehicle operator that suffers from disability or is immobile for any reason.

Certainly one could imagine different solutions to this problem, including self-locking and self-unlocking trailers and towing vehicles. However, such solutions are no more effective, nor cost-effective, and amount to “overkill” when compared to the present invention.

It would well serve those who must connect and disconnect towing and towed vehicles to provide something which is both effective and highly cost-effective to aid in the connection and disconnection of such vehicles.

### SUMMARY OF INVENTION

In view of the foregoing, it is an object of the present invention to provide a device which aids the driver of a towing vehicle to connect a towed vehicle without climbing into the towing vehicle.

It is another object of the present invention to provide a device which aids the driver of a towing vehicle to disconnect a towed vehicle without climbing into the towing vehicle.

It is another object of the present invention to provide a device which obviates the difficulty of towing and towed vehicle connecting procedures.

It is yet another object of the present invention to provide a device which obviates the difficulty of towing and towed vehicle disconnecting procedures.

In satisfaction of these and related objects, the present invention provides a simple, effective, cost-effective, and mobile device which affords the driver of a towing vehicle a simple way to connect and disconnect towing and towed vehicles. As will be detailed in the specification to follow, any embodiment of the present invention simply involves a first rod with specific curvatures that allow said rod to be used to connect and disconnect towing and towed vehicles by both lifting on the trailer handle or by pushing up on the trailer handle, and optionally, a second rod which can be used to extend the range of said first rod simply by linking the first rod and second rod.

Embodiments of the present invention are envisioned as being most beneficial in the context of connecting and disconnecting towing vehicles, such as trucks, and towed vehicles that contain spring-loaded hitches, such as bulldog hitches or similar hitches.

### BRIEF DESCRIPTION OF THE DRAWINGS

FIG. 1 is a perspective view of a towing and towed vehicle connecting and disconnecting assistance device in the context for use with towed vehicles that contain a spring-loaded hitch such as a bulldog hitch.

FIG. 2 is a perspective view of an extension rod which may be used to further the usable range of the towing and towed vehicle connecting and disconnecting assistance device of FIG. 1.

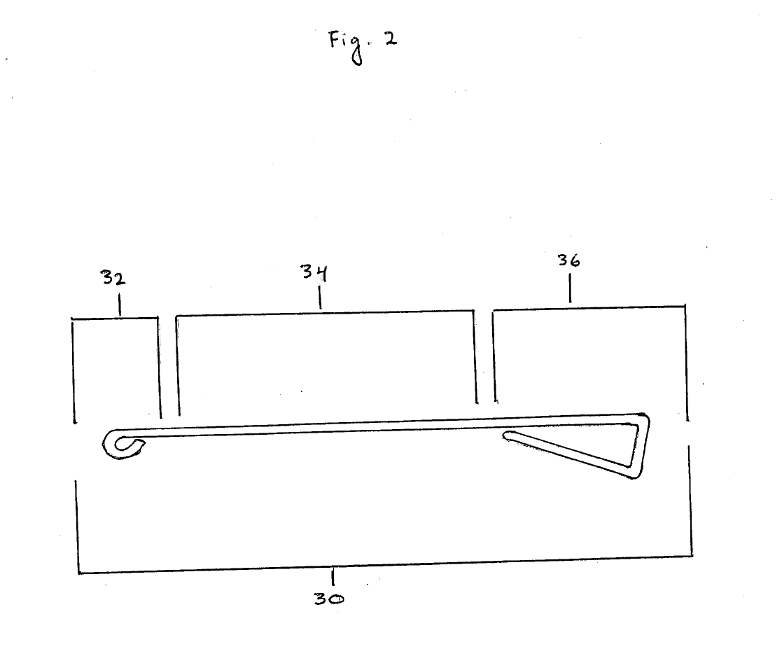

FIG. 3 is a perspective view of a towing and towed vehicle connecting and disconnecting assistance device shown with an extension device in an attached position in the context for use with towed vehicles that contain a spring-loaded hitch such as a bulldog hitch.

FIG. 4 is a perspective view of a towing and towed vehicle connecting and disconnecting assistance device reversibly mated with a spring-loaded hitch in a locked position wherein device 11 may be lifted in an upward direction thereby securing the spring-loaded hitch in an unlocked position

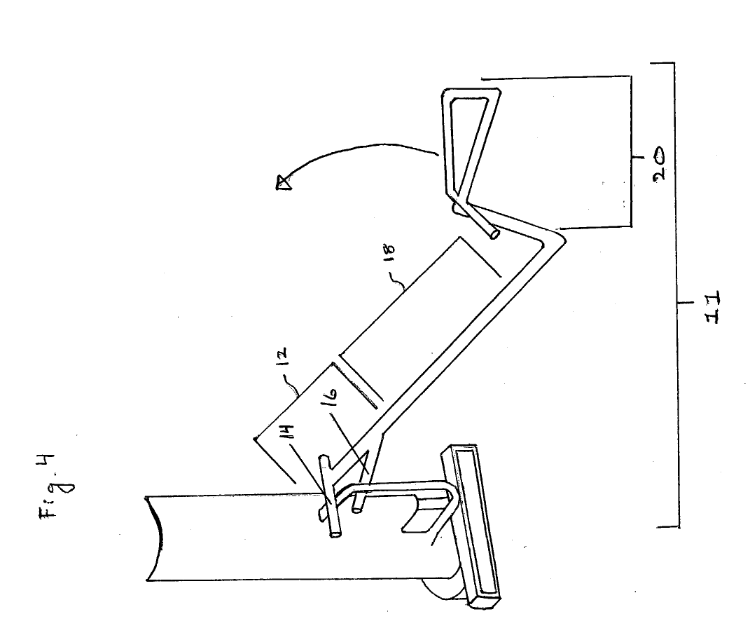

FIG. 5 is a perspective view of a towing and towed vehicle connecting and disconnecting assistance device reversibly mated with a spring-loaded hitch in an unlocked position wherein device 11 may be lowered in a downward direction thereby securing the spring-loaded hitch in a locked position

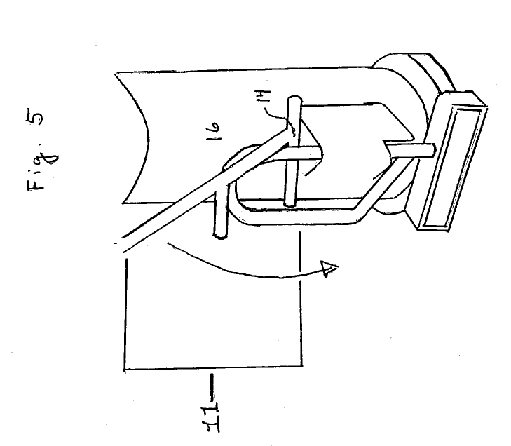

### DETAILED DESCRIPTION OF THE PREFERRED EMBODIMENT

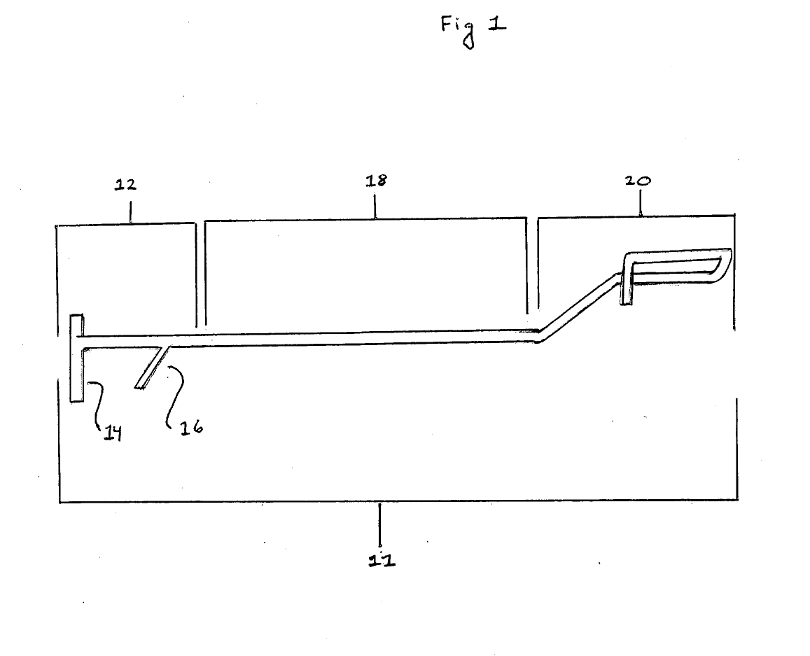

Referring to FIG. 1, the towing and towed vehicle connecting and disconnecting device of the present invention is identified generally by the reference numeral 10. Device 10 includes, in the preferred embodiment, a rod member 11. Rod member 11 includes a distal segment 12 to which is attached a first grasping element 14 and a second grasping element 16. Grasping members 14 and 16 are oriented and spaced to allow effective manipulation of a trailer handle where both elements 14 and 16 extend in a substantially coplanar direction to one another and both elements extend in a substantially perpendicular direction from said distal segment 12 of member rod 11.

Distal segment 12 provides means by which device 10 can be securely, but reversibly, attached to a trailer handle, allowing the user to lift up or push down on the trailer handle thereby connecting or disconnecting the towing and towed vehicles. Of course, alternative forms may be provided which involve unique grasping elements positioned at varying angles, but the just-described distal segment 12 is believed to be the preferred mode because of simplicity, ease of use, and effectiveness.

Extending linearly from distal segment 12 in a coplanar direction with respect to said first grasping element 14 and said second grasping element 16 is a medial segment 18 of rod 11. Medial segment 18 provides, in the preferred embodiment, means to secure distal segment 12 and proximate segment 20 in a fixed position relative to one another. In the preferred embodiment, medial segment 18 is of a fixed length. However, one can easily envision an adjustable length medial segment 18 to accommodate use with towing vehicles of different dimensions.

Attached to the proximate end 22 of medial segment 18 and extending in an upward direction relative to medial segment 18 and in an orthogonal plane with respect to said first grasping member 14 and said second grasping member 16 is proximate segment 20. In the preferred embodiment, proximate segment 20 is configured into a crook-like shape which is designed to serve as a handle for the user of device 10 and provide leverage for the actual use of device 10. Obviously, alternative embodiments for proximate segment 20 are easily envisioned for differing situations, such as when the present device is used with towing vehicles of different dimensions or users of different size or capabilities. However, the just-described proximate segment 20 is believed to be the preferred mode because of ease of use and effectiveness.

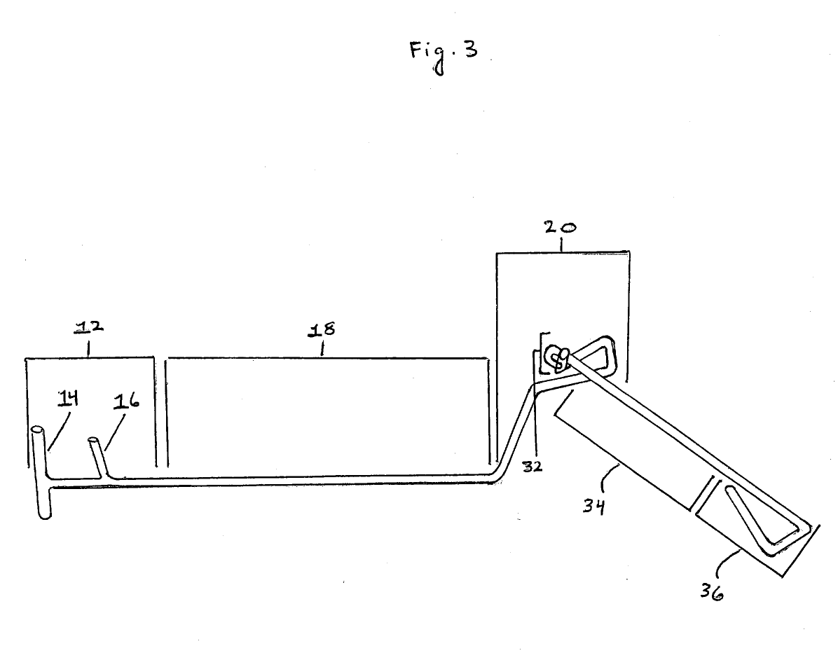

Referring to FIG. 3, extension rod 30 may be linked to device 10. In the preferred embodiment, extension rod 30 may be optionally mated with proximate segment 20 of rod 11 to increase the effective range of device 10. Extension rod 30 includes a distal extension rod segment 32 formed in the shape of a closed or semi-closed loop which provides means to join extension rod 30 with proximate segment 20 of rod 11, a medial extension rod segment 34 which extends linearly in a coplanar direction from distal extension rod segment 32, and provides means to secure distal segment 32 and proximate extension rod segment 36 in a fixed position relative to one another, a proximate extension rod segment 36 which extends linearly from medial extension rod segment 34 in a coplanar direction and is a crook formed in the shape of a handle.

It is believed that, while quite simple and inexpensive, the present device will obviate significant inconvenience and provide substantial utility to those who must connect and disconnect towing vehicles and towed vehicles, particularly without having to climb into the bed of the towing vehicle and act without the assistance of others.

Although the invention has been described with reference to specific embodiments, this description is not meant to be construed in a limited sense. Various modifications of the disclosed embodiments, as well as alternative embodiments of the inventions will become apparent to person skilled in the art upon the reference to the description of the invention. It is therefore contemplated that the appended claims will cover such modification that fall within the scope of the invention.

I claim:

1. A towing vehicle and towed vehicle connecting and disconnecting device comprising:
a first rod member having a distal segment, a medial segment, and a proximate segment where said distal segment extends linearly from the distal end of said medial segment;
attached to said distal segment and extending therefrom are first and second grasping elements spaced apart from each other, said first and second grasping elements extending in a coplanar direction with respect to one another and in a substantially perpendicular direction from said medial segment of said first rod member;
said medial segment extending linearly in a coplanar direction with respect to said first and second grasping elements, where said medial segment extend between and attaches said distal segment and said proximate segment; and
said proximate segment extending upwards in a substantially perpendicular direction with respect to said medial segment and extending in an orthogonal plane with respect to said first and second grasping members, said proximate segment being configured as a handle.

2. The device of claim 1 further comprising:
an extension rod member having a distal extension rod segment, a medial extension rod segment, and a proximate extension rod segment, said distal extension rod segment being formed as a semi-closed or closed loop extending from the distal extension rod end of the medial extension rod segment in a coplanar direction;
said medial extension rod segment extending linearly in a coplanar direction from said distal extension rod segment to said proximate extension rod segment;
said proximate extension rod segment extending linearly in a coplanar direction from the proximate extension rod end of said medial extension rod segment, where said proximate extension rod segment is formed as a crook which serves as a handle for the user of said extension member;
said extension rod member having connection means for engagement with said proximal segment of said first rod member.
